(19) United States
(12) Patent Application Publication
(10) Pub. No.: US 2008/0181064 A1
(43) Pub. Date: Jul. 31, 2008

(54) CONTENT PROCESSING APPARATUS

(75) Inventor: Satoshi SAITO, Ishikawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Osaka (JP)

(21) Appl. No.: 12/022,431

(22) Filed: Jan. 30, 2008

(30) Foreign Application Priority Data
Jan. 31, 2007 (JP) 2007-020405

(51) Int. Cl. G11B 5/09

(52) U.S. Cl. 369/47.15

(57) ABSTRACT

A content processing apparatus includes a CPU, and when a recording mode is selected, the CPU writes content data to a data area of an external memory. Management information recorded in a management area of the recording medium in order to manage the data recorded in the data area is updated in association with the writing processing. A distribution of a copying area formed across the data area and an internal memory is controlled by a controller such that a capacity of the data area is increased, a distribution ratio to the data area is increased. The management information recorded in the management area is copied in the copying area when a specific mode is selected. When a deleting operation is performed in the specific mode, a part of the information corresponding to desired content data recorded in the data area out of the management information recorded in the management area is deleted. The copied management information is written to the management area when a recovering operation is performed in the specific mode.

### CROSS REFERENCE OF RELATED APPLICATION

The disclosure of Japanese Patent Application No. 2007-20405 is incorporated herein by reference.

### BACKGROUND OF THE INVENTION

1. Field of the Invention

The present invention relates to a content processing apparatus. More specifically, the present invention relates to a content processing apparatus which is applied to a digital camera, and deletes content data recorded in a recording medium in response to a deleting operation.

2. Description of the Related Art

According to a related art, when an imaging operation is performed in an imaging mode, a JPEG file and file information for identifying this are written to a recording medium, and an FAT formed in the recording medium is updated. When a reproducing mode is selected, a deleting operation is made possible. The FAT formed in the recording medium is copied in an SDRAM in response to a first deleting operation. File information of a desired JPEG file recorded in the recording medium is copied in the SDRAM in response to a deleting operation, and then deleted from the recording medium. Furthermore, the FAT recorded in the recording medium is updated in association with the deleting processing. The copied FAT and file information are returned to the recording medium when a recovering operation is performed.

However, in the related art, the management information such as an FAT and file information is copied in the SDRAM. Thus, when a power sauce is turned off between the deleting operation and the following recovering operation, it is impossible to recover the recording medium to a state before the deleting operation. Furthermore, if management information is copied in a flash memory, such a problem is resolved, but if a size of the management information, that is, if a size of the recording medium is massive, it is impossible to execute copying processing.

### SUMMARY OF THE INVENTION

In one aspect of the present invention, a content processing apparatus, comprising: a first writer for writing content data to a data area of an external memory when a recording mode is selected; an updater for updating management information recorded in a management area of the external memory in association with the writing processing by the first writer in order to manage the data recorded in the data area; a controller for controlling a distribution of a copying area formed across the data area and an internal memory such that as a capacity of the data area is increased, a distribution ratio to the data area is increased; a copier for copying the management information recorded in the management area in the copying area when a specific mode is selected; a deleter for deleting a part of the information corresponding to desired content data recorded in the data area out of the management information recorded in the management area when a deleting operation is performed in the specific mode; and a second writer for writing the management information copied by the copier to the management area when a recovering operation is performed in the specific mode.

When a recording mode is selected, content data is written to a data area of an external memory by a first writer. An updater updates management information recorded in a management area of the external memory in association with the writing processing by the first writer in order to manage the data recorded in the data area. A distribution of a copying area formed across the data area and an internal memory is controlled by a controller such that a capacity of the data area is increased, a distribution ratio to the data area is increased.

The management information recorded in the management area is copied in the copying area by a copier when a specific mode is selected. A deleter deletes a part of the information corresponding to desired content data recorded in the data area out of the management information recorded in the management area when a deleting operation is performed in the specific mode. The management information copied by the copier is written to the management area by a second writer when a recovering operation is performed in the specific mode.

Since the management information is information for managing data recorded in the data area, the size of the management information is increased in proportion to the increase in the capacity of the data area. Thus, in this aspect, a distribution of the copying area formed across the data area and the internal memory is controlled such that as the capacity of the data area is increased, a distribution ratio to the data area is increased. Thus, even if the capacity of the data area, moreover, the size of the management information is massive, it is possible to recover the external memory to a state before the deleting operation.

It should be noted that in a preferred embodiment, the external memory is a memory card 34, but may be a recording medium such as a magnetic disk and a magneto-optical disk without being restricted to a semiconductor memory.

In another aspect of the present invention, a distribution of the copying area is controlled such that as a size of the management area is increased, a distribution ratio to the data area is increased.

In the other aspect of the present invention, a distribution of the copying area is controlled such that as a logical product of a capacity of the data area and a size of the management area is increased, a distribution ratio to the data area is increased.

### BRIEF DESCRIPTION OF THE DRAWINGS

FIG. 1 is a block diagram showing a configuration of one embodiment of the present invention;

FIG. 2 is an illustrative view showing one example of a mapping state of an SDRAM applied to FIG. 1 embodiment;

FIG. 3 is an illustrative view showing one example of a mapping state of a memory card applied to FIG. 1 embodiment;

FIG. 4(A) is an illustrative view showing one example of a distributed state of management information when a capacity of the memory card is equal to or less than 2 gigabytes;

FIG. 4(B) is an illustrative view showing one example of a distributed state of management information when a capacity of the memory card is above 2 gigabytes;

FIG. 5 is a flowchart showing a part of an operation of a CPU applied to FIG. 1 embodiment;

FIG. 6 is a flowchart showing another part of the operation of the CPU applied to FIG. 1 embodiment;

FIG. 7 is a flowchart showing a still another part of the operation of the CPU applied to FIG. 1 embodiment;

FIG. 8 is a flowchart showing a further part of the operation of the CPU applied to FIG. 1 embodiment;

FIG. 9 is a flowchart showing a still further part of the operation of the CPU applied to FIG. 1 embodiment;

FIG. 10 is a flowchart showing another part of the operation of the CPU applied to FIG. 1 embodiment;

FIG. 11 is an illustrative view showing another example of a distributed state of management information in another embodiment of the present invention;

FIG. 12 is a flowchart showing a part of an operation of the CPU applied to FIG. 11 embodiment;

FIG. 13 is a flowchart showing a part of an operation of the CPU applied to a still another embodiment of the present invention;

FIG. 14 is a flowchart showing a part of an operation of the CPU applied to a further another embodiment of the present invention;

FIG. 15 is a flowchart showing another part of the operation of the CPU applied to FIG. 14 embodiment;

FIG. 16 is a flowchart showing a part of an operation of the CPU applied to a further embodiment of the present invention;

FIG. 17 is a flowchart showing another part of the operation of the CUP applied to FIG. 16 embodiment;

FIG. 18 is a flowchart showing a part of an operation of the CPU applied to a still further embodiment of the present invention;

FIG. 19 is a flowchart showing a part of an operation of the CPU applied to another embodiment of the present invention;

FIG. 20 is a flowchart showing another part of the operation of the CPU applied to FIG. 19 embodiment; and

FIG. 21 is a flowchart showing a part of an operation of the CPU applied to a still another embodiment of the present invention.

### DETAILED DESCRIPTION OF THE PREFERRED EMBODIMENTS

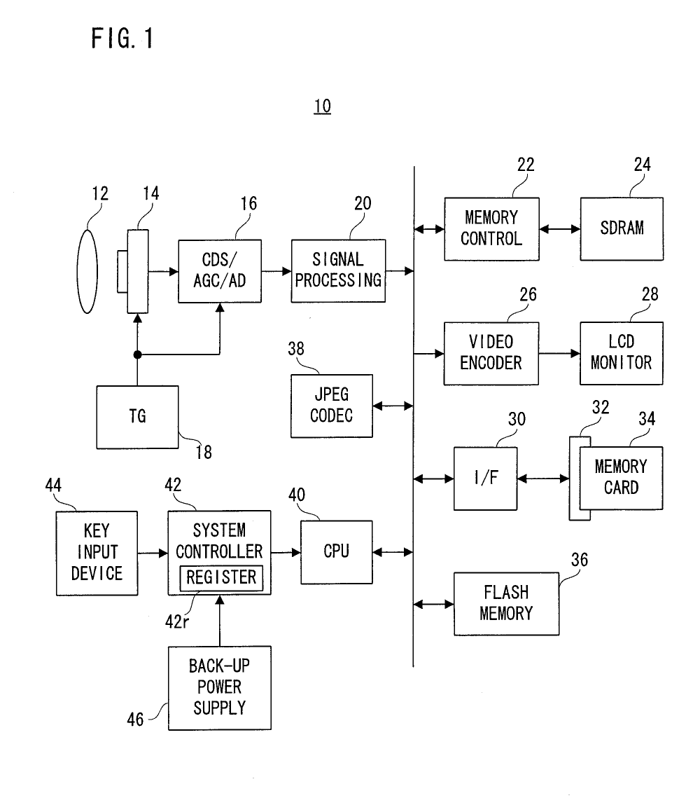

Referring to FIG. 1, a digital camera 10 of this embodiment includes an optical lens 12. An optical image of an object scene is irradiated onto an imaging surface of an image sensor 14 through the optical lens 12, and is subjected to photoelectronic conversion. As a result, a raw image signal showing an object scene is generated.

When a camera mode is selected, and an imaging operation is performed by an operation of a key input device 44 by a user, a corresponding notification is applied to a CPU 40 from a system controller 42. The CPU 40 instructs a TG (Timing Generator) 18 to perform a primary exposure. The image sensor 14 is subjected to a primary exposure by the TG 18, and outputs a raw image signal thus generated in a raster scanning manner. A CDS/AGC/AD circuit 16 performs a series of processing, such as correlative double sampling, an automatic gain adjustment and an A/D conversion on the raw image signal output from the image sensor 14 to output raw image data being a digital signal.

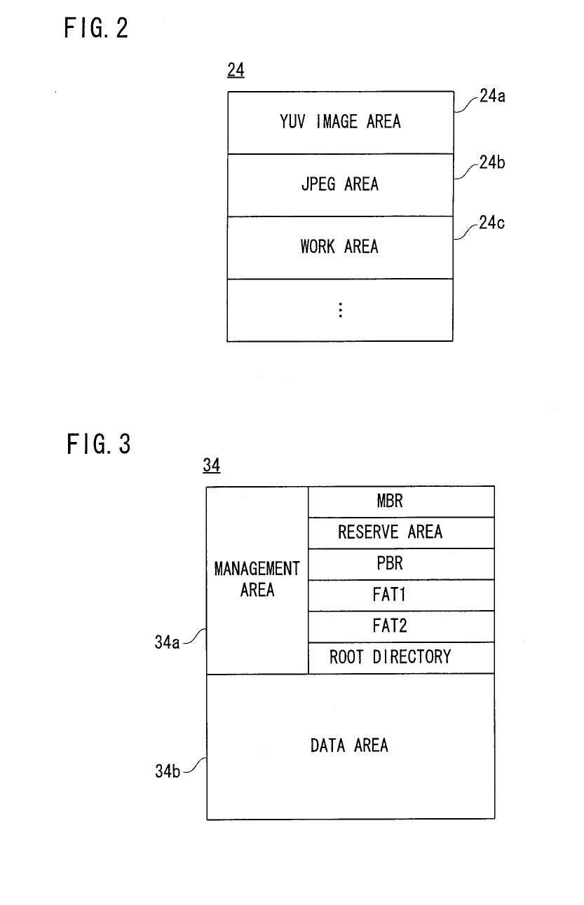

A signal processing circuit 20 performs processing such as a white balance adjustment, a color separation, a YUV conversion, etc. on the raw image data output from the CDS/AGC/AD circuit 16 to write image data in a YUV format thus generated to an SDRAM 24 through a memory control circuit 22. In the SDRAM 24, a YUV area 24a, a JPEG area 24b, a work area 24c, etc. are formed in a manner shown in FIG. 2. The image data from the signal processing circuit 20 is written to the YUV area 24a.

A JPEG codec 38 reads the image data stored in the YUV area 24a through the memory control circuit 22, compresses the read image data in a JPEG system, and writes compressed image data, that is, JPEG data to the JPEG area 24b of the SDRAM 24 through the memory control circuit 22. The object scene image at a time when an imaging operation is performed is retained in the JPEG area 24b as JPEG data by execution of the foregoing imaging processing.

Referring to FIG. 3, the memory card 34 is a memory card formatted in an MS-DOS system, and has a management area 34a and a data area 34b. The management area 34a is formed with an MBR (Master Boot Record), a reserve area, a PBR (Partition Boot Record), an FAT (File Allocation Table) 1, an FAT 2 as a copy of the FAT 1, and a root directory.

Here, the data area 34b is formed by a plurality of clusters (unit of recording area). One data file extends over a plurality of clusters, and a linked state of the plurality of clusters to which the data file is written is managed by the FAT 1 and the FAT 2. Furthermore, file information (a filename, a size, a creation date, etc.) for identifying a data file is written to the root directory. It should be noted that the FAT 2 is a copy of the FAT 1, and overwrites the FAT 1 when the FAT 1 is destroyed.

The CPU 40 reads the JPEG data stored in the JPEG area 24b through the memory control circuit 22, and records a JPEG file including the read JPEG data to the data area 34b of the memory card 34 through an I/F 30. The CPU 40 further writes the recorded file information of the JPEG file to the root directory, and updates the FAT 1 and the FAT 2. Here, the format of the above-described memory card 34 is strictly classified as “FAT 16” and “FAT 32”.

The memory card 34 is a detachable nonvolatile recording medium, and is made accessible by the CPU 40 when it is attached to a slot 32. The memory card 34 is attached or detached when a main power supply is in an off state, and the attachment and detachment of the memory card 34 is monitored by the system controller 42 backed up by a back-up power supply 46. When the attachment and detachment of the memory card 34 occurs, a variable K on a register 42r is set to “1” by the system controller 42. When the main power supply is turned on without occurrence of the attachment and detachment of the memory card 34, the variable K is set to “2” by the system controller 42. When the back-up power supply 46 is run out to stop the system controller 42, the variable K is reset to “0”.

When a reproducing mode is selected by an operation of the key input device 44, a corresponding notification is applied from the system controller 42 to the CPU 40. The CPU 40 accesses the memory card 34 through the I/F 30, and reads the JPEG data stored in the desired JPEG file. The read JPEG data is written to the JPEG area 24b of the SDRAM 24 through the memory control circuit 22.

The JPEG codec 38 reads the JPEG data from the JPEG area 24b through the memory control circuit 22, expands the read JPEG data, and writes the expanded image data to the YUV area 24a of the SDRAM 24 through the memory control circuit 22. A video encoder 26 reads the image data stored in the YUV area 24a through the memory control circuit 22, converts the read image data into a composite video signal in an NTSC system, and outputs the converted composite video signal to an LCD monitor 28. As a result, a reproduced image is displayed on the monitor screen.

When an updating operation is performed by the key input device 44, a corresponding notification is applied from the system controller 42 to the CPU 40. The CPU 40 notes another JPEG file to execute processing as described above. As a result, the reproduced image displayed on the monitor screen is updated with another reproduced image.

When a deleting operation is performed by the key input device 44, a corresponding notification is applied form the system controller 42 to the CPU 40. The CPU 40 reads an FAT 1 from the management area 34a of the memory card 34 through the I/F 30, and saves the read FAT 1 in the work area 24c of the SDRAM 24. The saved FAT 1 is then copied in the flash memory 36 or the data area 34b of the memory card 34. That is, if a capacity of the memory card 34 is equal to or less than 2 gigabytes, the flash memory 36 is regarded as a copying destination, and if the capacity of the memory card 34 is above 2 gigabytes, the data area 34b is regarded as a copying destination.

The CPU 40 reads file information of a JPEG file which is currently being reproduced from the root directory of the memory card 34. The read file information is saved in the work area 24c of the SDRAM 24, and then copied in the flash memory 36. The CPU 40 deletes the file information from the root directory after completion of such copying processing, and updates the FAT 1 and the FAT 2 in correspondence with the deleting processing. As a result, the JPEG file which is currently being reproduced is actually deleted from the memory card 34.

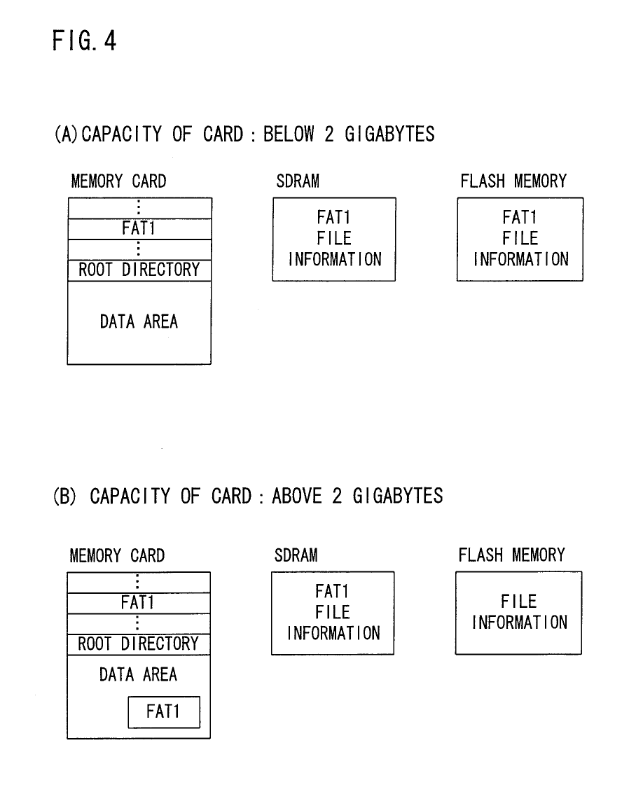

With reference to FIG. 4(A) and FIG. 4(B), if the capacity of the memory card 34 is equal to or less than 2 gigabytes, the FAT 1 and the file information are distributed to the memory card 34, the SDRAM 24 and the flash memory 36 as shown in FIG. 4(A). On the other hand, if the capacity of the memory card 34 is above 2 gigabytes, the FAT 1 and the file information are distributed to the memory card 34, the SDRAM 24 and the flash memory 36 as shown in FIG. 4(B).

When the FAT 1 and the file information are collectively called “management information”, and an area for storing copied management information is defined as a “copying area”, a distribution ratio of the copying area between the flash memory 36 and the data area 34b is changed depending on the capacity of the memory card 34. That is, if the capacity of the memory card 34 is equal to or less than a threshold value (=2 gigabytes), the entire copying area is assigned to the flash memory 36. On the other hand, if the capacity of the memory card 34 is above the threshold value, a part of the copying area is assigned to the flash memory 36, and the other part of the copying area is assigned to the data area 34b.

A size of the management information (especially, FAT 1) is increased in proportion to the capacity of the data area 34b. Here, in this embodiment, a distribution of the copying area formed across the data area 34b and the flash memory 36 is controlled such that as the capacity of the data area 34b is increased, the distribution ratio to the data area 34b is increased. Thus, even if the capacity of the data area 34b, moreover, the size of the management information is massive, it is possible to precisely store the copied management information.

When a recovering operation is performed by the key input device 44 after the deleting operation, a corresponding notification is applied to the CPU 40 from the system controller 42. The CPU 40 reads the FAT 1 saved in the work area 24c through the memory control circuit 22, and records the read FAT 1 in the management area 34a of the memory card 34 through the I/F 30. The FAT 1 and the FAT 2 of the management area 34a are updated by the FAT 1 saved in the work area 24c. The CPU 40 reads the file information saved in the work area 24c through the memory control circuit 22, and records the read file information in the root directory of the memory card 34 through the I/F 30. As a result, the file information which has been deleted in response to the deleting operation is returned to the original. The JPEG file which has been deleted by the deleting operation is recovered by such a recovering processing.

When a power-off operation is performed by the key input device 44 after the completion of the deleting operation, the main power supply is turned off to stop power supply to the entire system including the CPU 40. It should be noted that as described above, the system controller 42 is backed up by the back-up power supply 46, and the attachment and detachment of the memory card 34 is monitored by the system controller 42. When the attachment and detachment of the memory card 34 occurs with the main power supply in an off state, the variable K on the register 42r is set to “1”. Furthermore, when a power-on operation is performed by the key input device 44 without the attachment and detachment of the memory card 34, the main power supply is turned on, and the variable K is updated to “2”. On the other hand, when the back-up power supply 46 is run out with the main power supply in an off state to stop the system controller 42, the variable K is reset to “0”.

Accordingly, when a power-on operation is performed, reliability of the FAT 1 and the file information stored in the copying area is determined with reference to the variable K. The CPU 40 considers that the reliability of the FAT 1 and the file information on the copying area is high when the variable K shows “2”, and transmits the FAT 1 and the file information to the work area 24c on the SDRAM 24. Thus, even if a power-off operation and a power-on operation are inserted between a deleting operation and a successive recovering operation, it is possible to surely recover deleted JPEG file.

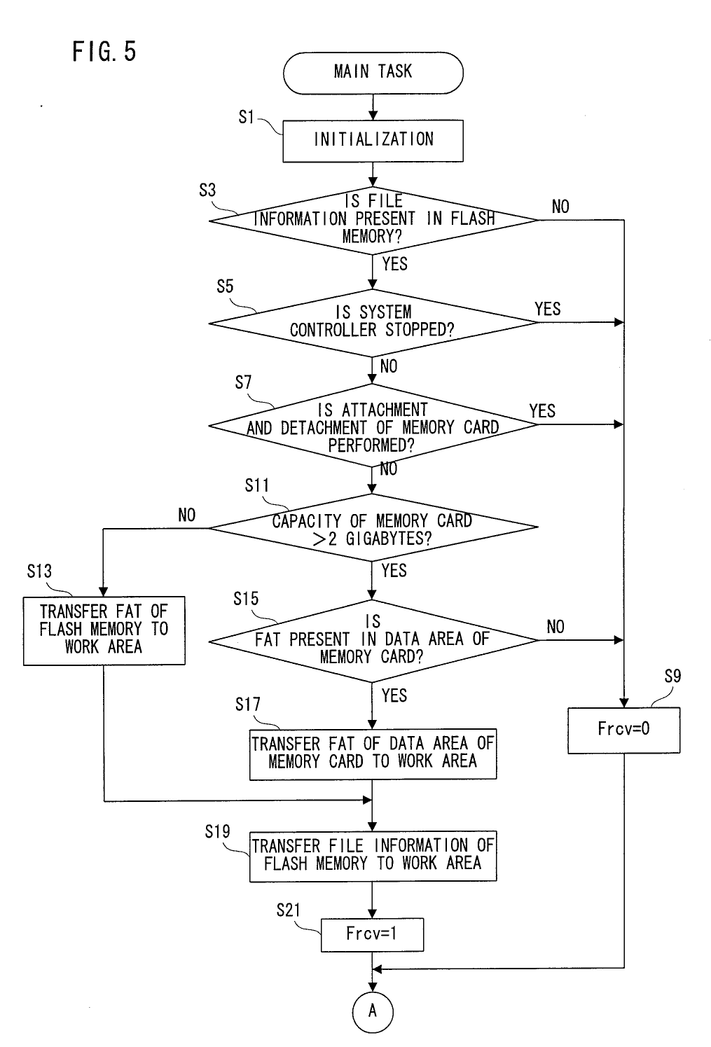

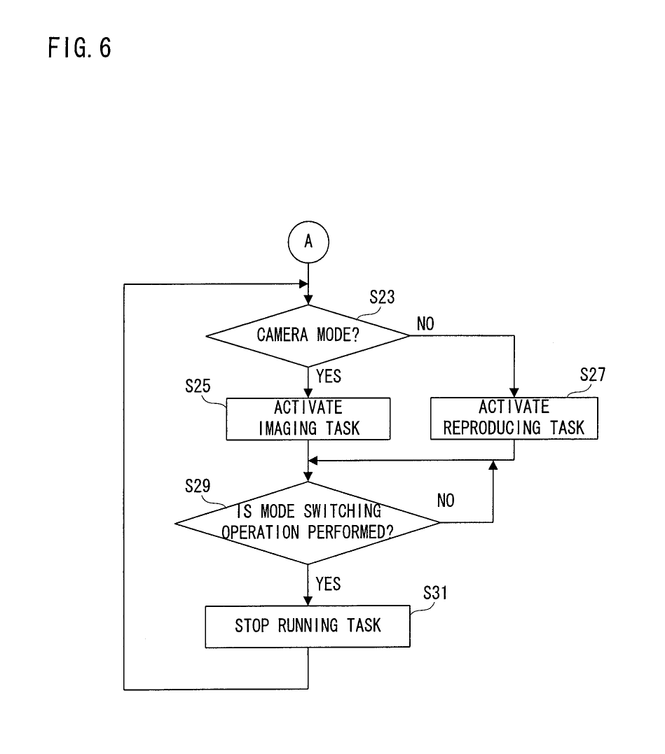

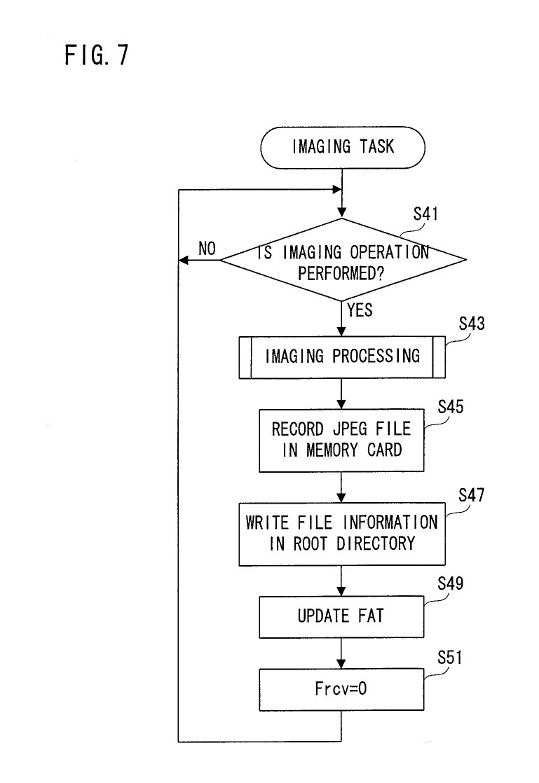

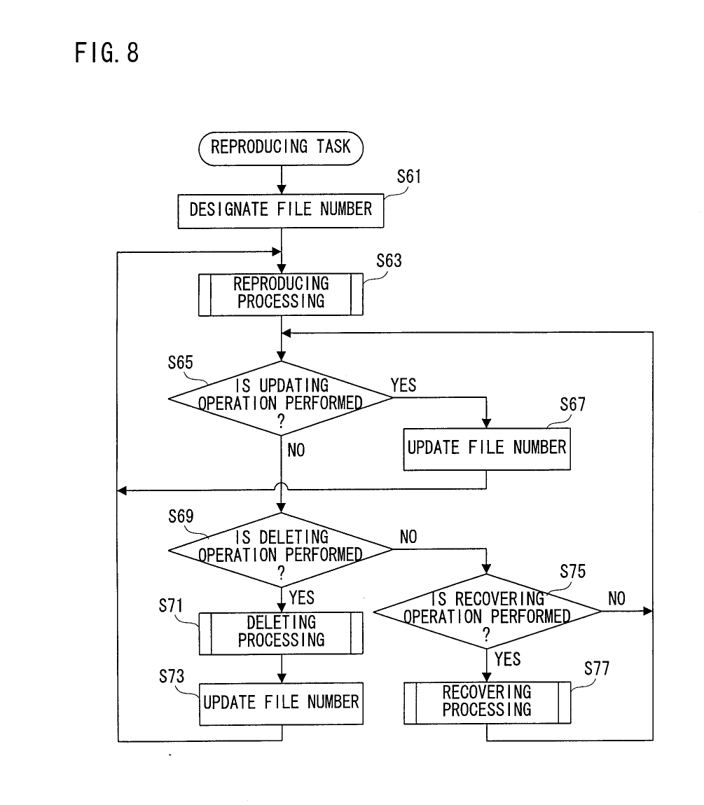

The CPU 40 executes in parallel a plurality of tasks including a main task shown in FIG. 5-FIG. 6, an imaging task shown in FIG. 7, a reproducing task shown in FIG. 8-FIG. 11. It should be noted that a control program corresponding to these tasks are stored in the flash memory 36.

Referring to FIG. 5, when a power-on operation is performed by the key input device 44, initialization processing is first executed in a step S1. Thus, the work area 24c of the SDRAM 24 (see FIG. 2) is cleared. In a step S3, it is determined whether or not file information is present in the flash memory 36, and in a step S5, it is determined whether or not the system controller 42 is stopped, and in a step S7, it is determined whether or not attachment and detachment of the memory card 34 is performed.

If file information is not present in the flash memory 36, it is considered that there is no JPEG file to be recovered, and a flag Frcv is set to “0” in a step S9. Setting the flag Frcv to “0” clearly shows that recovering processing is impossible.

In each of the steps S5 and S7, a determination processing is performed by noting a variable K on the register 42r. If the variable K shows “0”, it is considered that the system controller 42 is stopped during the time from the power-off operation to the power-on operation, and the process proceeds from the step S5 to the step S9. If the variable K shows “1”, it is considered that the attachment and detachment of the memory card 34 occurs during the time from the power-off operation to the power-on operation, and the process proceeds from the step S7 to the step S9. If the variable K shows “2”, it is considered that the attachment and detachment of the memory card 34 does not occur, and the file information stored in the flash memory 36 is file information useful for recovering processing, and the process proceeds to a step S11.

In the step S11, it is determined whether or not the capacity of the memory card 34 is above 2 gigabytes. If “NO” here, it is considered that the FAT 1 is stored in the flash memory 36, and the FAT is transferred to the work area 24c of the SDRAM 24 (see FIG. 2) in a step S13. If “YES” in the step S11, it is determined whether or not the FAT 1 is recorded in the data area 34b of the memory card 34. If “NO” here, the flag Frcv is set to “0” in the step S9 while if YES, the FAT 1 is transferred from the data area 34b of the memory card 34 to the work area 24b of the SDRAM 24 in a step S17.

After completion of the processing in the step S13 or S17, the process proceeds to a step S19 to transfer the file information stored in the flash memory 36 to the work area 24c of the SDRAM 24. In a step S21, the flag Frcv is set to “1” in order to show that recovering the deleted JPEG file is possible.

In a step S23, it is determined whether or not a mode which is currently being selected is a camera mode. If “YES” here, an imaging task is activated in a step S25, and if “NO”, a reproducing task is activated in a step S27. After completion of the processing in the step S25 or S27, it is determined whether or not a mode switching operation is performed in a step S29. If “YES” here, the running task is stopped in a step S31 and then, the process returns to the step S23.

With reference to FIG. 7, in a step S41, it is determined whether or not an imaging operation is performed. If “YES” here, imaging processing is performed in a step S43. As a result, JPEG data corresponding to an object scene image when the imaging operation is performed is retained in the JPEG area 24b of the SDRAM 24 (see FIG. 2(A)).

In a step S45, a JPEG file including the JPEG data stored in the JPEG area 24b is recorded in the data area 34b of the memory card 34. In a step S47, file information for identifying the JPEG file thus recorded is written to the root directory of the memory card 34, and in a succeeding step S49, the FATs 1 and 2 in the management area 34a are updated such that a link is formed among the clusters in which the JPEG file is recorded.

After completion of updating the FATs 1 and 2, the flag Frcv is set to “0” in a step S51. That is, as a result of the processing in the step S49, because consistency between the FAT 1 saved in the work area 24c and the FAT 1 recorded in the management area 24c of the memory card 34 cannot be maintained, the flag Frcv is set to “0” in order to show that recovering the deleted JPEG file is made impossible. After completion of the process in the step S51, the process returns to the step S41.

Referring to FIG. 8, in a step S61, a certain file number is designated, and in a step S63, reproducing processing is performed on a JPEG file corresponding to the designated file number. As a result, a reproduced image is output from the LCD monitor 28. When a file number updating operation is performed, “YES” is determined in a step S65, the file number is updated in step S67, and then, the process returns to the step S63. As a result, the reproduced image output from the LCD monitor 28 is updated.

When a deleting operation is performed in a step S69, “YES” is determined to execute deleting processing in a step S71. In the succeeding step S73, the file number is updated and then, the process returns to the step S63. When a recovering operation is performed, “YES” is determined in a step S75, recovering processing is performed in a step S77, and then, the process returns to the step S65.

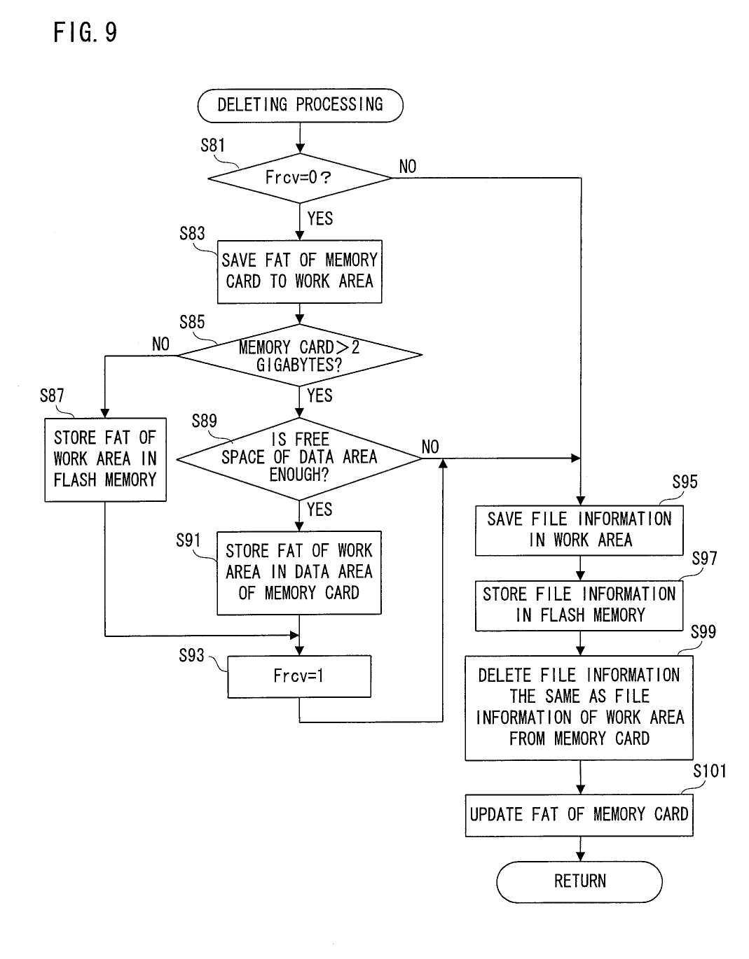

The deleting processing in the step S71 complies with a subroutine shown in FIG. 9. In a step S81, a state of the flag Frcv is determined. If the flag Frcv is “1”, the process proceeds to a step S95 as it is while if the flag Frcv is “0”, the FAT 1 of the memory card 34 is saved in the work area 24c in a step S83. In a step S85, it is determined whether or not the capacity of the memory card 34 is above 2 gigabytes.

If “NO” here, the process proceeds to a step S87 to store the FAT 1 of the work area 24c in the flash memory 36. If “YES” in the step S85, the process proceeds to a step S89 to determine whether or not a free space of the data area 34b is enough. If “NO” here, the process proceeds to the step S95 while if “YES”, the FAT 1 of the work area 24c is stored in the data area 34b of the memory card 34 in a step S91. After completion of the processing in the step S87 or S91, the flag Frcv is set to “1” in a step S93, and the process proceeds to the step S95.

The size of the FAT 1 is fixed, and a saved position of the FAT 1 on the work area 24c, a stored position of the FAT 1 on the flash memory 36, and a stored position of the FAT 1 on the data area 34b of the memory card 34 are also fixed. Thus, the FAT 1 which is positioned in the work area 24c, the flash memory 36 or the data area 34b is updated by the latest FAT 1.

In the step S95, file information of a JPEG file which is being currently reproduced is saved in the work area 24c. In a step S97, file information the same as that saved in the work area 24c is stored in the flash memory 36, and in a succeeding step S99, file information the same as that saved in the work area 24c is deleted from the root directory of the memory card 34. In a step S101, the FATs 1 and 2 are updated in correspondence with the deleting processing in the step S97. After completion of updating the FATs 1 and 2, the process is restored to the routine at the hierarchical upper level.

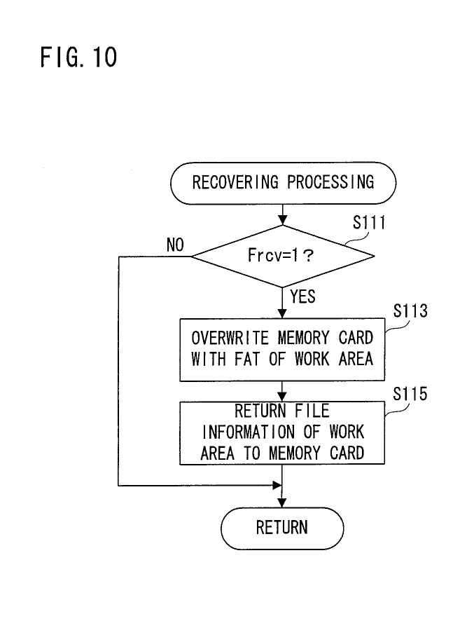

The recovering processing in the step S77 shown in FIG. 8 complies with a subroutine shown in FIG. 10. First, in a step S111, a state of the flag Frcv is determined. If the flag Frcv is “0”, the process is restored to the routine at the hierarchical upper level. On the contrary thereto, if the flag Frcv is “1”, the FAT 1 of the work area 24c is transmitted to the memory card 34 in a step S113. Each of the FATs 1 and 2 on the management area 34a of the memory card 34 are overwritten by the FAT 1 saved in the work area 24c. In a step S115, the file information saved in the work area 24c is returned to the root directory of the memory card 34.

In a case that an imaging operation is performed between a plurality of deleting operations, saved file information in response to the deleting operation before the imaging operation and saved file information in response to the deleting operation after the imaging operation are mixed in the work area 24c. In the step S115, among these file information, the saved file information in response to the deleting operation after the imaging operation is returned to the root directory. After completion of the processing in the step S115, the process is restored to the routine at the hierarchical upper level.

As understood from the above description, a JPEG file (content data) is written to the data area 34b of the memory card 34 by the CPU 40 when the camera mode (recording mode) is selected (S45). The CPU 40 updates an FAT 1 (arrangement information) and file information (identification information) recorded in the management area 34a of the memory card 34 in association with the writing processing of the JPEG file in order to manage the data recorded in the data area 34b (S47, S49). A distribution of the copying area formed across the data area 34b and the flash memory 36 is controlled by the CPU 40 such that as a capacity of the data area 34b is increased, a distribution ratio to the data area 34b is increased (S85).

The FAT 1 and the file information recorded in the management area 34a are copied in the copying area by the CPU 40 when a reproducing mode (specific mode) is selected (S87, S91, S97). When a deleting operation is performed in the reproducing mode, the CPU 40 deletes file information of a desired JPEG file recorded in the data area 34b among the file information recorded in the management area 34a (S99). When a recovering operation is performed in the reproducing mode, the FAT 1 and the file information which are copied in the copying area are written to the management area 34a by the CPU 40 (S113, S115).

Since the FAT 1 and the file information are information for managing the JPEG files recorded in the data area 34b, the sizes (especially, the size of the FAT 1) are increased in proportion to increase in the capacity of the data area 34b. Here, in this embodiment, the distribution of the copying area formed across the data area 34b and the flash memory 36 is controlled such that as the capacity of the data area 34b is increased, a distribution ratio to the data area 34b is increased. Thus, even if the capacity of the data area 34b, moreover, the size of the FAT 1 is massive, it is possible to recover the memory card 34 to the state before the deleting operation.

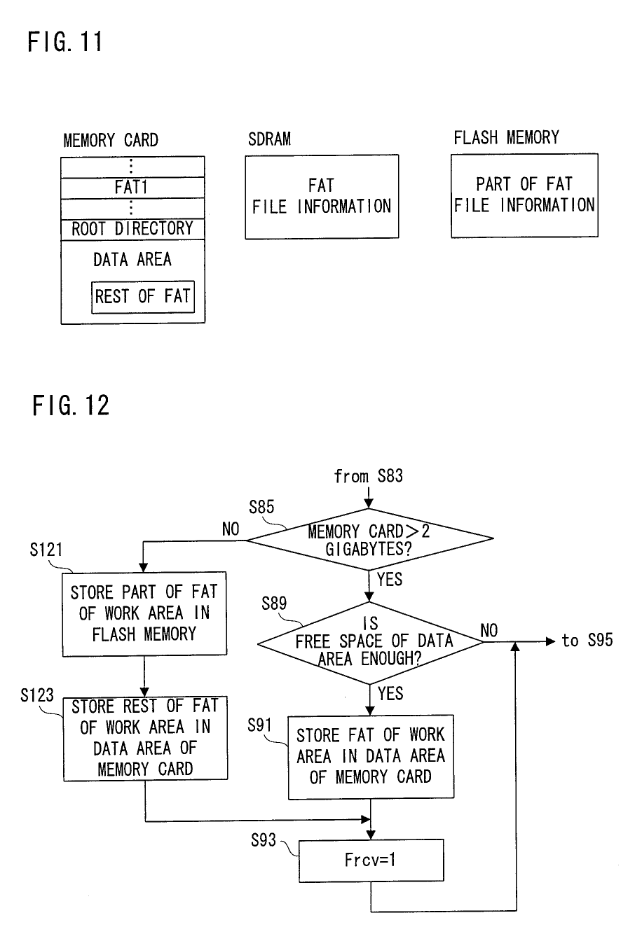

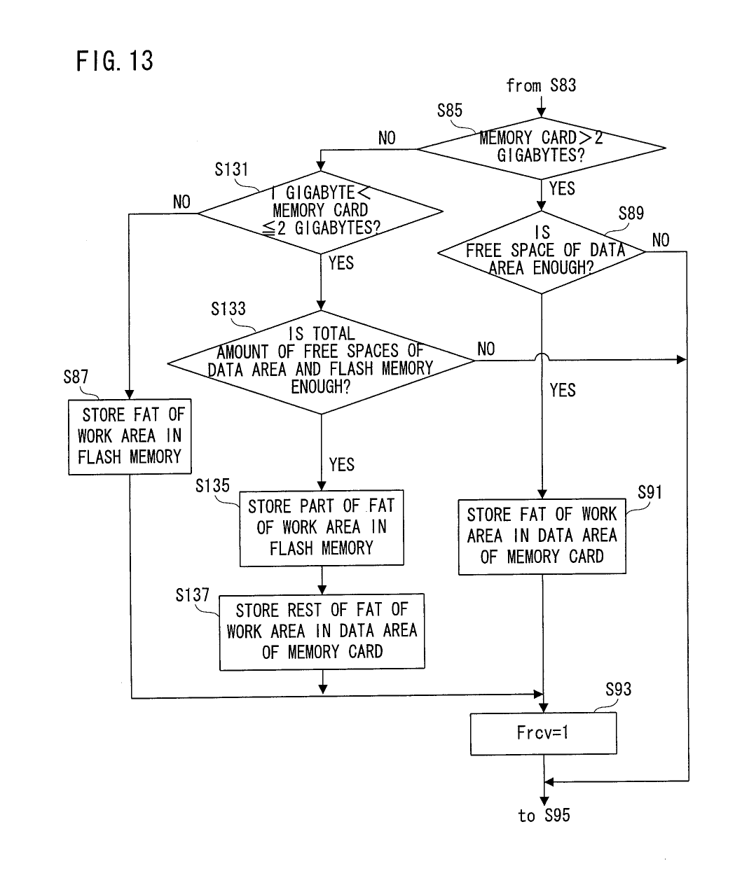

Additionally, in this embodiment, as understood from the processing in the step S85-S91 in FIG. 9, the FAT 1 is collectively copied in any one of the flash memory 36 and the data area 34b depending on the capacity of the memory card 34. However, when the capacity of the memory card 34 is small, a part of the FAT 1 is stored in the flash memory 36 and the rest of the FAT 1 may be stored in the data area 34b of the memory card 34 as shown in FIG. 11. In this case, as shown in FIG. 12, processing in steps S121 and S123 need to be executed in place of the processing in the step S89, and processing in steps S131-S137 shown in FIG. 13 need to be additionally executed.

Referring to FIG. 12, the step S121 is processing for storing a part of the FAT 1 saved in the work area 24c in the flash memory 36, and the step S123 is processing for storing the other part of the FAT 1 saved in the work area 24c in the data area 34b of the memory card 34. Referring to FIG. 13, the step S131 is determination processing whether or not the capacity of the memory card 34 falls within a range from 1 gigabyte to 2 gigabytes, and the step S133 is processing for determining whether or not a total amounts of the free spaces of the data area 34b and the flash memory 36 is enough. The processing in the steps S135 and S137 are the same as those in the steps S121 and S123 shown in FIG. 12, respectively.

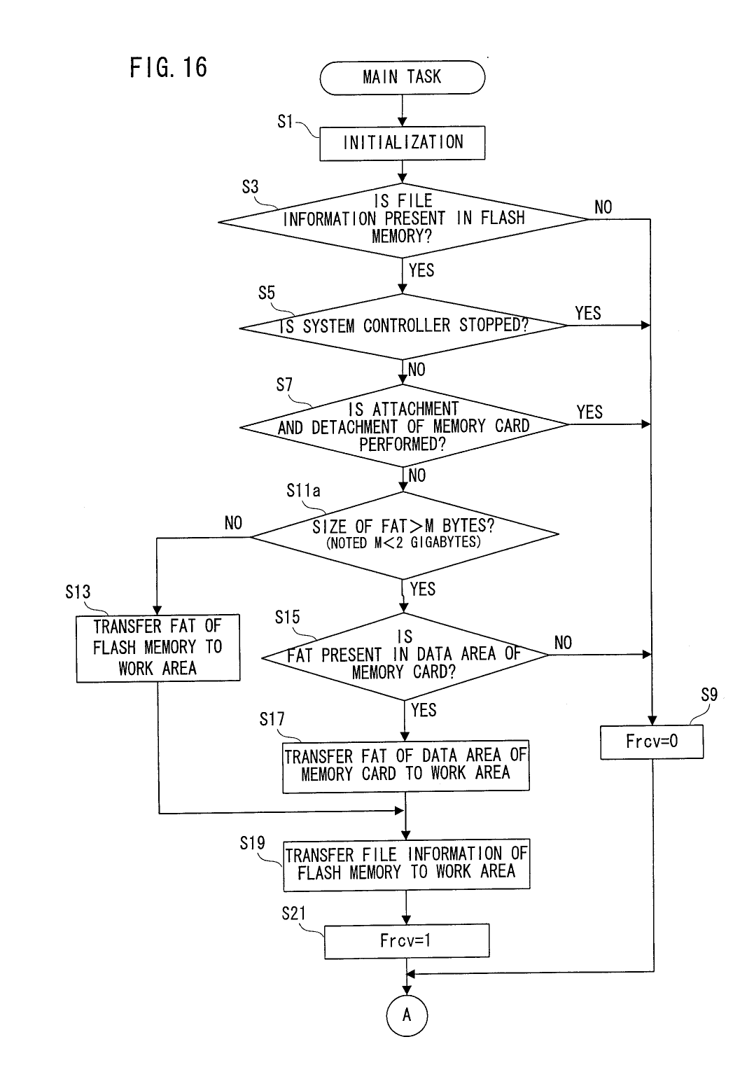

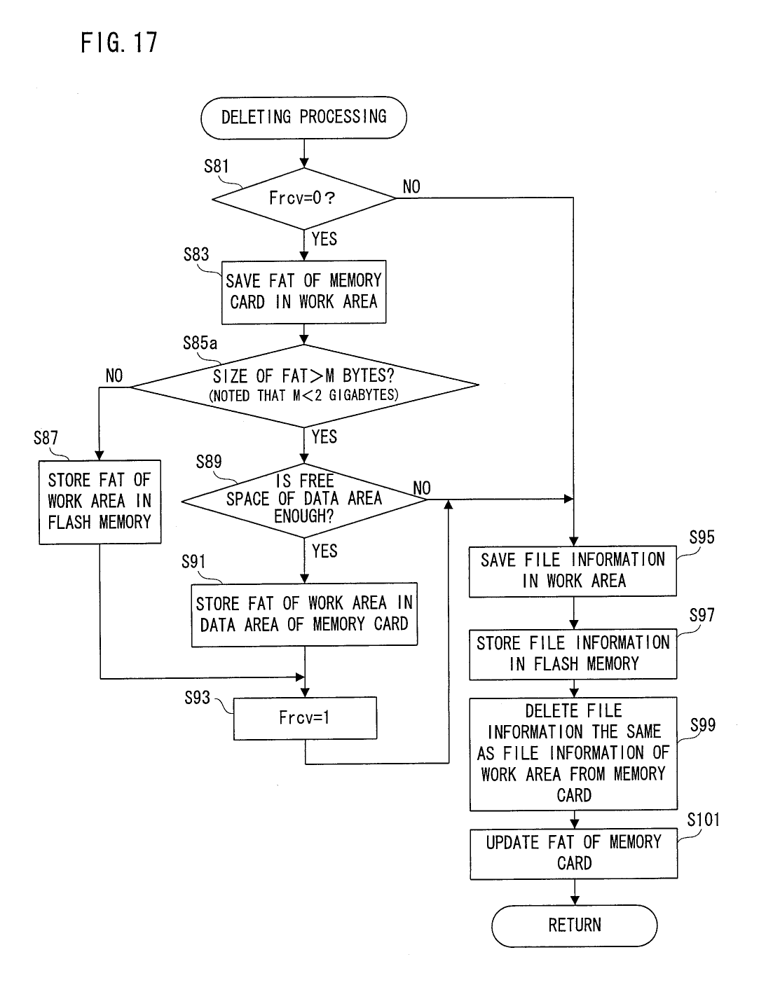

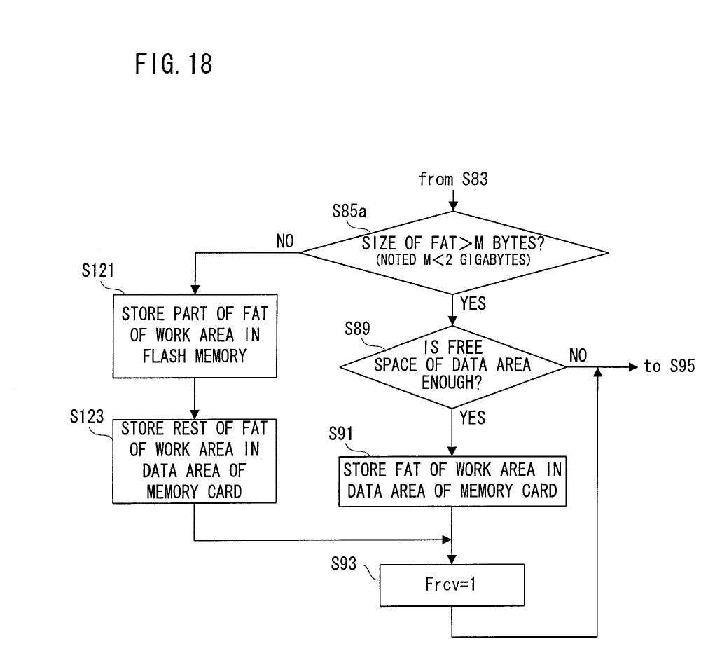

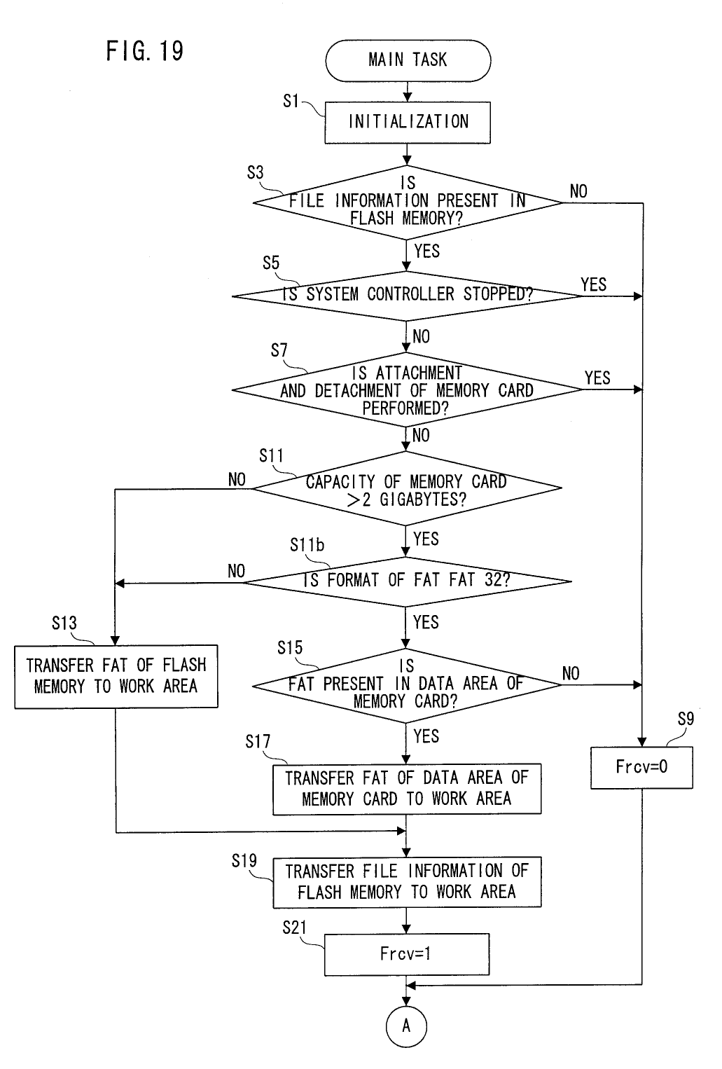

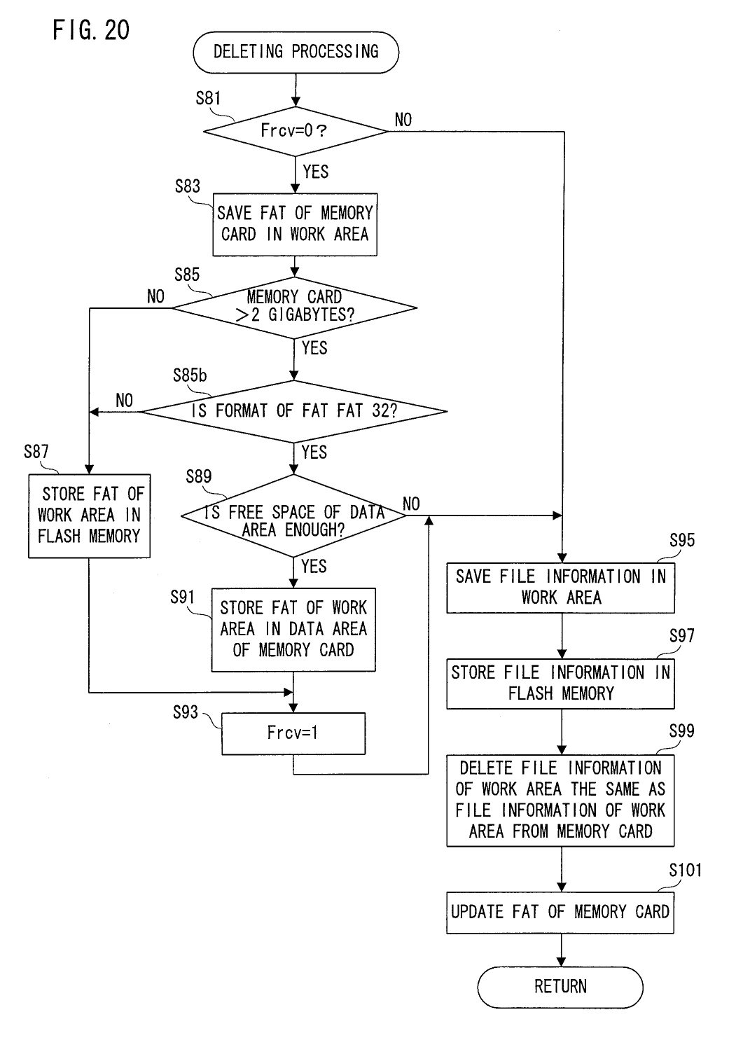

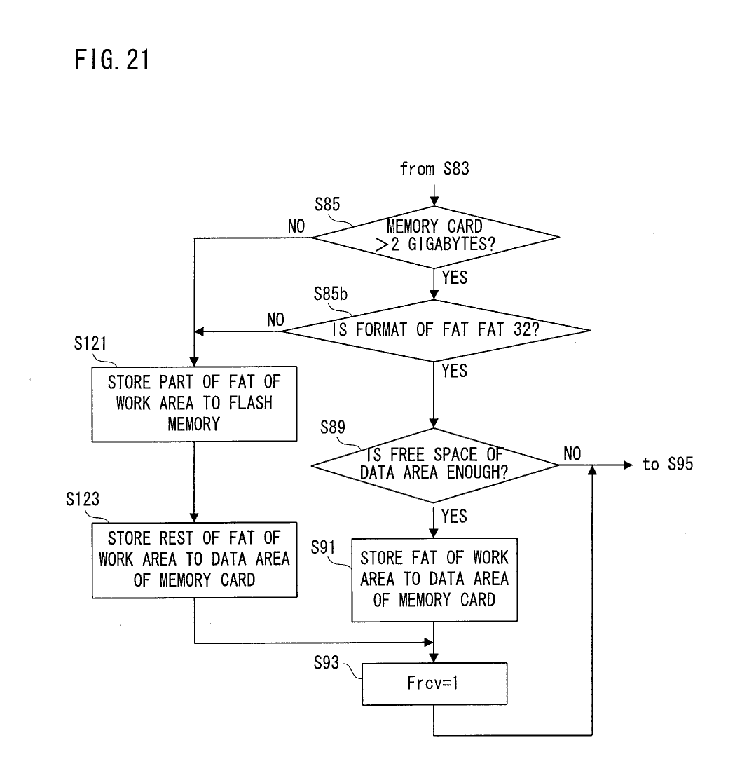

Furthermore, in this embodiment, the capacity of the memory card 34 is noted in order to control the distribution ratio of the copying area. Alternatively, the sizes of the FAT 1 or the FAT 2 may be noted (see S11a in FIG. 16, S85a in FIG. 17 and S85a in FIG. 18). In addition, whether the format of the memory card 34 is either the “FAT 16” or the “FAT 32” may be noted (see S11b in FIG. 19, S85b in FIG. 20 and S85b in FIG. 21).

In a main task shown in FIG. 16, the step S11a is executed when “NO” is determined in the step S7. In the step S11a, it is determined whether or not the size of the FAT 1 or the FAT 2 is above M bytes (noted, M<2 gigabytes). If “NO” here, the process proceeds to the step S13 while if “YES”, the process proceeds to the step S15. The rest of the steps are the same as those in FIG. 5.

It should be noted that in a case that the memory card 34 of 2G bytes is formatted by the FAT 32, the size of the management area 34a becomes, although being different depending on the size of the cluster, generally several megabytes. For this reason, the threshold M can be 1 megabyte, for example.

In a deleting processing shown in FIG. 17, the step S85a is executed following the step S83. In the step S85a, a determination similar to the foregoing step S11a is performed. If “NO” here, the process proceeds to a step S87, and if “YES”, the process proceeds to a step S89. The rest of the steps are the same as those in FIG. 9.

In deleting processing shown in FIG. 18, the step S85a is executed following a step S83. In the step S85a, a determination similar to the foregoing step S11a is performed. If “NO” here, the process proceeds to the step S121, and if “YES”, the process proceeds to the step S89. The rest of the steps are the same as those in FIG. 12.

According to FIG. 16-FIG. 18, the distribution of the copying area is controlled such that as the size of the management area 34a is increased, the distribution ratio to the data area 34b is increased.

In a main task shown in FIG. 19, the step S11b is executed when “YES” is determined in the step S11. In the step S11b, it is determined whether or not the format of the FAT 1 or the FAT 2 is the FAT 32, and if “NO” here, (that is, if the FAT 16), the process proceeds to the step S13, and if “YES” (that is, if the FAT 32), the process proceeds to the step S15. The other steps are the same as those in FIG. 5.

In deleting processing shown in FIG. 20, the step S85b is executed when “YES” determined in the step S85. In the step S85b, a determination similar to the foregoing step S11b is performed. If “NO” here, the process proceeds to the step S87, and if “YES”, the process proceeds to the step S89. The other steps are the same as those in FIG. 9.

In also the deleting processing shown in FIG. 21, the step S85b is executed when “YES” is determined in the step S85. In the step S85b, a determination similar to the above-described step S11b is performed. If “NO” here, the process proceeds to the step S121, and if “YES”, the process proceeds to the step S89. The other steps are the same as those in FIG. 12.

Generally, even if the management information is the same, if the format is different between the FAT 16 and the FAT 32, the size is larger in the latter case than in the former case. Thus, in FIG. 19-FIG. 21, the format of the management information, moreover, the size of the management area 34a are also noted other than the capacity of the data area 34b.

According to FIG. 19-FIG. 21, a distribution of the copying area is controlled such that as a logical product of the capacity of the data area 34b and the size of the management area 34a is increased, the distribution ratio to the data area 34b is increased.

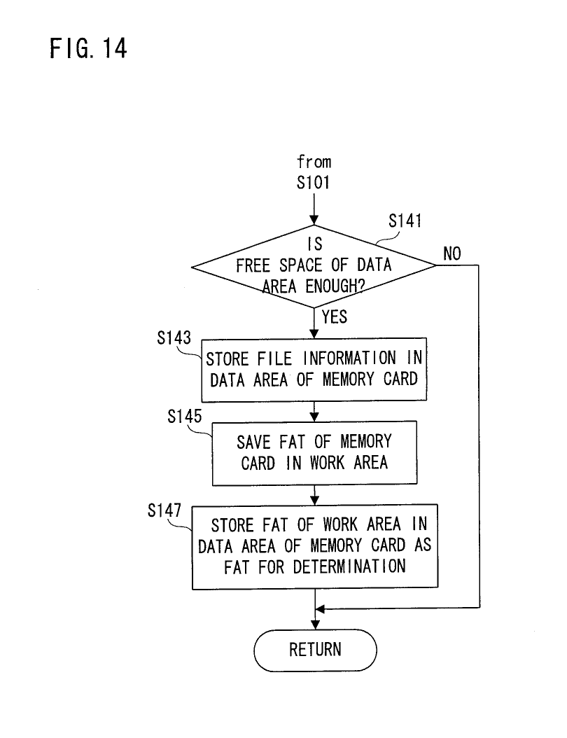

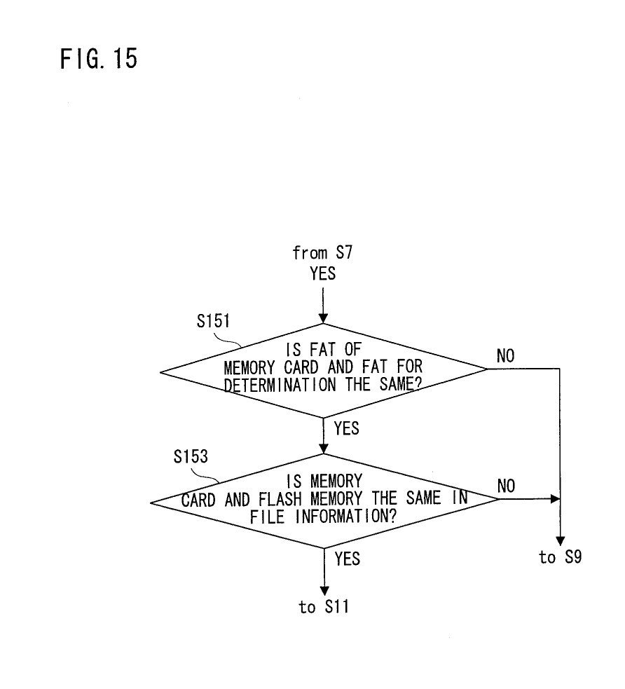

Furthermore, in this embodiment, as understood from the processing in the step S7 in FIG. 5, after attachment and detachment of the memory card, recovering the JPEG file which has already been deleted is made impossible. However, by inserting steps S141-S147 shown in FIG. 14 after the step S101 shown in FIG. 9, and adding steps S151, S153 shown in FIG. 15 in FIG. 5, it is possible to provide an embodiment in which recovering is made possible after attachment and detachment of the memory card 34.

That is, in the step S101 shown in FIG. 9, after the FATs 1 and 2 of the memory card 34 are updated, it is determined whether or not a free space of the data area 34b is enough in the step S141 shown in FIG. 14. If “NO” here, the process is restored to the routine at hierarchical upper level. On the other hand, if “YES”, the file information is stored in the data area 34b of the memory card 34 in the step S143, and the FAT 1 of the memory card 34 is saved in the work area 24c in the step S145, the FAT 1 saved in the work area 24c is stored in the data area 34b of the memory card 34 as an FAT for determination in the step S147, and the process is restored to the routine at the hierarchical upper level.

The FAT for determination is for determining whether or not the FATs 1 and 2 of the memory card 34 are updated because writing or erasing data is performed on the memory card 34 in an apparatus other than the digital camera 10 during a time from detachment of the memory card 34 from the digital camera 10 to attachment to the digital camera 10 again. If the FAT for determination and the FAT 1 of the memory card 34 are the same, it is determined that the updating has not been performed.

In a case of the memory card 34 on which the processing in the steps S145 and S151 are performed, this allows a recovery after the attachment and detachment of the memory card. That is, when attachment and detachment of the memory card 34 is determined in the step S7 as shown in FIG. 5, it is determined whether or not the FAT 1 of the memory card 34 and the FAT for determination stored in the data area 34b of the memory card 34 are the same in the step S151 shown in FIG. 15. If “NO” here, that is, if both of them are different from each other, or the FAT for determination is not present in the data area 34b of the memory card 34, the process proceeds to the step S9.

On the other hand, if “YES” is determined in the step S151, it is determined that writing or erasing data is not performed on the memory card 34 in an apparatus other than the digital camera 10 during a time from detachment of the memory card 34 from the digital camera 10 to attachment to the digital camera 10 again, and in the step S153, it is determined whether or not the file information stored in the data area 34b of the memory card 34 is the same as the file information which is present in the flash memory 36 within the digital camera 10.

If “NO” here, the process proceeds to the step S9 while if “YES”, it is determined that deleting processing of the JPEG file by the digital camera 10 is not performed during a time from detachment of the memory card 34 from the digital camera 10 to attachment to the digital camera 10 again and the memory card 34 which has been detached once is attached again, and the processing after the step S11 are performed. This makes it possible to perform the processing after the step S11 after the attachment and detachment of the memory card 34, allowing recovery.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content processing apparatus, comprising:
a first writer for writing content data to a data area of an external memory when a recording mode is selected;
an updater for updating management information recorded in a management area of said external memory in association with the writing processing by said first writer in order to manage the data recorded in said data area;
a controller for controlling a distribution of a copying area formed across said data area and an internal memory such that as a capacity of said data area is increased, a distribution ratio to said data area is increased;
a copier for copying the management information recorded in said management area in said copying area when a specific mode is selected;
a deleter for deleting a part of the information corresponding to desired content data recorded in said data area out of the management information recorded in said management area when a deleting operation is performed in said specific mode; and
a second writer for writing the management information copied by said copier to said management area when a recovering operation is performed in said specific mode.

2. A content processing apparatus according to claim 1, wherein
said management information includes identification information for identifying content data recorded in said external memory and arrangement information for indicating an arrangement state of the content data recorded in said external memory,
said copying area includes a first area for storing said identification information and a second area for storing said arrangement information, and
said controller controls a distribution of said second area.

3. A content processing apparatus according to claim 1, wherein
said controller assigns said entire second area to said data area when a capacity of said external memory is above a threshold value, and assigns said entire second area to said internal memory when a capacity of said external memory is equal to or less than said threshold value.

4. A content processing apparatus according to claim 1, wherein
said controller assigns said entire second area to said data area when a capacity of said external memory is above a first threshold value, assign distributedly said second area to said data area and said internal memory when a capacity of said external memory is equal to or less than said first threshold value and above a second threshold value, and assigns said entire second area to said internal memory when a capacity of said external memory is equal to or less than said second threshold value.

5. A content processing apparatus according to claim 1, wherein said internal memory is non-volatile.

6. A content processing apparatus according to claim 1, further comprising a reproducer for reproducing desired content data when a reproducing mode is selected, wherein said specific mode is the reproducing mode, and said deleting operation is directed to the content data which has been reproduced by said reproducer.

7. A recording medium recording a content processing program to be executed by a content processing apparatus, wherein
said content processing program causes a processor of said content processing apparatus to execute:
a first writing step for writing content data to a data area of an external memory when a recording mode is selected;
an updating step for updating management information recorded in a management area of said external memory in association with the writing processing by said first writing step in order to manage the data recorded in said data area;
a controlling step for controlling a distribution of a copying area formed across said data area and an internal memory such that as a capacity of said data area is increased, a distribution ratio to said data area is increased;
a copying step for copying the management information recorded in said management area in said copying area when a specific mode is selected;
a deleting step for deleting a part of the information corresponding to desired content data recorded in said data area out of the management information recorded in said management area when a deleting operation is performed in said specific mode; and
a second writing step for writing the management information copied by said copying step to said management area when a recovering operation is performed in said specific mode.

8. A content processing method to be executed by a content processing apparatus, comprising:
a first writing step for writing content data to a data area of an external memory when a recording mode is selected;
an updating step for updating management information recorded in a management area of said external memory in association with the writing processing by said first writing step in order to manage the data recorded in said data area;
a controlling step for controlling a distribution of a copying area formed across said data area and an internal memory such that as a capacity of said data area is increased, a distribution ratio to said data area is increased;
a copying step for copying the management information recorded in said management area in said copying area when a specific mode is selected;
a deleting step for deleting a part of the information corresponding to desired content data recorded in said data area out of the management information recorded in said management area when a deleting operation is performed in said specific mode; and
a second writing step for writing the management information copied by said copying step to said management area when a recovering operation is performed in said specific mode.

9. A content processing apparatus, comprising:
a first writer for writing content data to a data area of an external memory when a recording mode is selected;
an updater for updating management information recorded in a management area of said external memory in association with the writing processing by said first writer in order to manage the data recorded in said data area;
a controller for controlling a distribution of a copying area formed across said data area and an internal memory such that as a size of said management area is increased, a distribution ratio to said data area is increased;
a copier for copying the management information recorded in said management area in said copying area when a specific mode is selected;
a deleter for deleting a part of the information corresponding to desired content data recorded in said data area out of the management information recorded in said management area when a deleting operation is performed in said specific mode; and
a second writer for writing the management information copied by said copier to said management area when a recovering operation is performed in said specific mode.

10. A content processing apparatus, comprising:
a first writer for writing content data to a data area of an external memory when a recording mode is selected;
an updater for updating management information recorded in a management area of said external memory in association with the writing processing by said first writer in order to manage the data recorded in said data area;
a controller for controlling a distribution of a copying area formed across said data area and an internal memory such that as a logical product of a capacity of said data area and a size of said management area is increased, a distribution ratio to said data area is increased;
a copier for copying the management information recorded in said management area in said copying area when a specific mode is selected;
a deleter for deleting a part of the information corresponding to desired content data recorded in said data area out of the management information recorded in said management area when a deleting operation is performed in said specific mode; and
a second writer for writing the management information copied by said copier to said management area when a recovering operation is performed in said specific mode.

11. A content processing method to be executed by a content processing apparatus, comprising:
a first writing step for writing content data to a data area of an external memory when a recording mode is selected;
an updating step for updating management information recorded in a management area of said external memory in association with the writing processing by said first writing step in order to manage the data recorded in said data area;
a controlling step for controlling a distribution of a copying area formed across said data area and an internal memory such that as a logical product of a capacity of said data area and a size of said management area is increased, a distribution ratio to said data area is increased;
a copying step for copying the management information recorded in said management area in said copying area when a specific mode is selected;
a deleting step for deleting a part of the information corresponding to desired content data recorded in said data area out of the management information recorded in said management area when a deleting operation is performed in said specific mode; and
a second writing step for writing the management information copied by said copying step to said management area when a recovering operation is performed in said specific mode.
